(19) United States
(12) Patent Application Publication
(10) Pub. No.: US 2006/0044428 A1
(43) Pub. Date: Mar. 2, 2006

(54) Image pickup device and signal processing method

(75) Inventor: Seiji Tanaka, Saitama-ken (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/210,678

(22) Filed: Aug. 25, 2005

(30) Foreign Application Priority Data
Sep. 1, 2004 (JP) 2004-254350

(51) Int. Cl. H04N 9/04; H04N 3/14

(52) U.S. Cl. 348/272

(57) ABSTRACT

The present invention provides an image pickup device and a signal processing method which can reduce false colors and improve a sense of resolution. After a signal processing section carries out pixel mixing, the signal processing section carries out LPF processing on G pixels so as to correspond to an interval and a phase-of R pixels or B pixels, and determines correlation values of the G pixels, which have been subjected to the LPF processing, and the R pixels and the B pixels. After interpolation processing of the G pixels is carried out, the R pixels and the B pixels are interpolated on the basis of the G pixels and the correlation values.

### CROSS-REFERENCE TO RELATED APPLICATION

This application claims priority under 35 USC 119 from Japanese Patent Application No. 2004-254350, the disclosure of which is incorporated by reference herein.

### BACKGROUND OF THE INVENTION

1. Field of the Invention

The present invention relates to an image pickup device and a signal processing method, and in particular, to an image pickup device and a signal processing method which mix signals of respective pixels outputted from a solid state image pickup element, and carry out a predetermined signal processing thereon.

2. Description of the Related Art

Increasing the transfer speed of one frame is being carried out by mixing together pixels read-out from a CCD image sensor, and thereafter, transferring them. However, with a pixel mixing method, the phases of the pixels become offset, and false colors arise in a color interpolation method similar to still images.

In order to prevent false colors, there is disclosed an image pickup device which does not carry out thinning processing, in a case in which an image, which is picked-up by an image pickup element, is displayed at a number of pixels which is less than the number of pixels of that image pickup element (see, for example, Japanese Patent Application Laid-Open (JP-A) No. 9-331538).

The image pickup device disclosed in JP-A No. 9-331538 has an image pickup element having, at the image pickup surface thereof, four color filters having different spectral characteristics. These color filters are disposed with respect to the horizontal direction such that mutually different color filters repeat in periods of two pixels, and are disposed with respect to the vertical direction such that mutually different color filters repeat in periods of two pixels and one line of every four lines is offset in the horizontal direction by one pixel.

Every 4N lines (N is an integer of greater than or equal to one) of the image pickup element, the above-described image pickup device reads-out signals of two lines of pixels, and alternately carries out addition of signals of two pixels which are adjacent in an oblique direction of the signals of the two lines, and addition of signals of two pixels which are adjacent in the vertical direction. In this way, the image pickup device can carry out reading-out by thinning signals of pixels of predetermined lines from the image pickup element, and can form a color video signal from the signals which are thinned and read-out.

Further, there is disclosed a signal processing device which carries out color interpolation without losing the color of the DC component, and without generating a new false color even in an object image of a high frequency and a high saturation (see, for example, JP-A No. 2002-300590).

The signal processing device disclosed in JP-A No. 2002-300590 has a first color difference signal computing component which separates colors in a direction of a high degree of correlation and computes a first color difference signal, a second color difference signal computing component which computes a second color difference signal by a predetermined computation which is different than that of the first color difference signal computing component, a saturation detecting circuit computing first and second saturation values from the first and second color difference signals, and a selector selecting and outputting either the first or the second color difference signal, on the basis of the first and second saturation values. As a result, at a portion which has a Nyquist frequency and at which there is the possibility that the horizontal/vertical determination will be an erroneous determination, color difference signals, which are obtained by carrying out color separation from both the vertical direction and the horizontal direction, are outputted.

Moreover, a digital camera has been disclosed which suppresses the generation of false signals and false colors, in a case in which pixels of the same color are mixed-together and a low-resolution image is generated (see, for example, JP-A No. 2003-299112). This digital camera disclosed in JP-A No. 2003-299112 has a CCD of a honeycomb arrangement. At the (4 k+1)th and (4 k+2)th rows, the central positions of mixed pixels of B color and G color are fixed, and the central positions of mixed pixels of R color of the (4 k+1)th row are shifted to predetermined positions by a weighting processing. In this way, because the positions of the mixed pixels are uniform in units of one row, the generation of false signals and false colors when generating an image from mixed pixels is suppressed.

However, the image pickup device disclosed in JP-A No. 9-331538 has the problems that the resolution decreases and the image quality deteriorates, because reading-out is carried out by thinning signals of pixels of predetermined rows from the image pickup element. The signal processing device of JP-A No. 2002-300590 suppresses false colors arising when generating color difference signals, and does not consider phase offset caused by pixel mixing.

Further, the digital camera disclosed in JP-A No. 2003-299112 merely shifts the central positions of the mixed pixels of R color, after the pixels of the respective colors are mixed together. Therefore, between R color and G color, and between B color and G color, offset in the spatial frequency remains as is, and there is the problem that false colors are generated.

### SUMMARY OF THE INVENTION

The present invention has been proposed in order to overcome the above-described problems, and an object of the present invention is to provide an image pickup device and a signal processing method which can reduce false colors and improve the sense of the resolution.

An image pickup device of a first aspect of the present invention has: a solid state image pickup element in which a plurality of pixels are disposed in a state in which a square grid is rotated by substantially 45°, and pixels of red color and blue color are disposed alternately in even-numbered rows or odd-numbered rows, and only pixels of green color are disposed in odd-numbered rows or even-numbered rows; a pixel mixing component mixing together each predetermined number of signals of same-colored pixels read-out from the solid state image pickup element, and generating a pixel signal for each of red color, green color and blue color; a filter carrying out filter processing on the pixel signal of green color generated by the pixel mixing component, so as to correspond to a mixing interval of the pixel signal of red color or blue color generated by the pixel mixing component; a correlation value computing component computing a correlation value of the pixel signal of red color or blue color generated by the pixel mixing component, and the pixel signal of green color which has been subjected to the filter processing; and an interpolating component generating interpolation signals of red color or blue color on the basis of the pixel signal of green color generated by the pixel mixing component, and the correlation value computed by the correlation value computing component.

A signal processing method of a second aspect of the present invention includes: mixing together each predetermined number of signals of same-colored pixels from a solid state image pickup element in which a plurality of pixels are disposed in a state in which a square grid is rotated by substantially 45°, and in which pixels of red color and blue color are disposed alternately in even-numbered rows or odd-numbered rows, and only pixels of green color are disposed in odd-numbered rows or even-numbered rows, and generating a pixel signal for each of red color, green color and blue color; carrying out filter processing on the pixel signal of green color, so as to correspond to a mixing interval of the generated pixel signal of red color or blue color; computing a correlation value of the generated pixel signal of red color or blue color, and the pixel signal of green color which has been subjected to the filter processing; and generating interpolation signals of red color or blue color, on the basis of the generated pixel signal of green color and the computed correlation value.

In the solid state image pickup element, the plurality of pixels are disposed in a state in which a square grid is rotated by substantially 45°, and, for example, the pixels of red color and blue color are disposed alternately in even-numbered rows and only pixels of green color are disposed in odd-numbered rows. Note that the colors of the pixels disposed in the even-numbered rows and the odd-numbered rows may be different.

The pixel mixing component generates a pixel signal for each of red color, green color, and blue color, by mixing together each predetermined number of signals of same-colored pixels read-out from the solid state image pickup element. This predetermined number may be different for each color.

The filter carries out filter processing on the pixel signal of green color generated by the pixel mixing component, so as to correspond to a mixing interval of the pixel signal of red color or blue color. In this way, it is easy to make the pixel signal of red color or blue color, and the pixel signal of green color which has been subjected to filter processing, correspond to one another, and these pixel signals are set in a state in which the correlation therebetween can be obtained.

The correlation value computing component computes a correlation value of the pixel signal of red color or blue color generated by the pixel mixing component, and the pixel signal of green color which has been subjected to the filter processing. The correlation value is a value expressing the correlation between the pixel signal of red color or blue color, and the pixel signal of green color which has been subjected to the filter processing. Therefore, if a pixel signal of green color which is a reference exists, it is possible to determine the pixel signal of red color or blue color corresponding thereto.

The interpolating component generates interpolation signals of red color or blue color on the basis of the pixel signal of green color generated by the pixel mixing component, and the correlation value computed by the correlation value computing component. In this way, it is possible to obtain a pixel signal of red color or blue color whose spatial frequency is similar to that of the pixel signal of green color after interpolation processing, and which does not have phase offset. Because this pixel signal of red color or blue color is determined by taking into consideration the correlation with the pixel signal of green color, false colors can be suppressed.

Accordingly, in accordance with the image pickup device and signal processing method relating to the present invention, filter processing is carried out on a pixel signal of green color so as to correspond to a mixing interval of a pixel signal of red color or blue color, and a correlation value between the pixel signal of red color or blue color and the pixel signal of green color which has been subjected to the filter processing is computed, and interpolation signals of red color or blue color are generated on the basis of the pixel signal of green color and the correlation value. In this way, the generation of false colors can be suppressed, and the sense of resolution can be improved.

Here, the interpolating component may generate interpolation signals of green color on the basis of the pixel signal of green color generated by the pixel mixing component, and, on the basis of the interpolation signals of green color and the correlation value, may generate interpolation signals of red color or blue color of a same spatial frequency as a spatial frequency of the interpolation signals of green color. In this way, the spatial frequencies of the interpolation signals of red color, blue color and green color can be made to be equal and high, and phase offset thereof can be suppressed.

Further, the filter may carry out the filter processing on the pixel signal of green color, so as to correspond to a phase of the pixel signal of red color or blue color.

In accordance with the image pickup device and signal processing method relating to the present invention, filter processing is carried out on a pixel signal of green color so as to correspond to a mixing interval of a pixel signal of red color or blue color, and a correlation value between the pixel signal of red color or blue color and the pixel signal of green color which has been subjected to the filter processing is computed, and interpolation signals of red color or blue color are generated on the basis of the pixel signal of green color and the correlation value. In this way, the generation of false colors can be suppressed, and the feeling of the resolution can be improved.

### BRIEF DESCRIPTION OF THE DRAWINGS

FIG. 1 is a block diagram showing the structure of an image pickup device relating to an embodiment of the present invention;

FIG. 2 is a diagram showing the arrangement of photodiodes of a CCD image sensor;

FIG. 3 is a flowchart showing the order of processings of pixel interpolation by a signal processing section;

FIG. 4 is a diagram showing spatial phase offset for pixels obtained by pixel mixing;

FIGS. 5A through 5F are diagrams showing phase offset and intervals of pixels obtained by pixel mixing and of pixels which have been subjected to signal processing; and

FIG. 6 is a diagram showing GLPF_R1 and GLPF_B3 which are G pixels after LPF processing.

### DETAILED DESCRIPTION OF THE INVENTION

A best mode for embodying the present invention will be described hereinafter in detail with reference to the drawings.

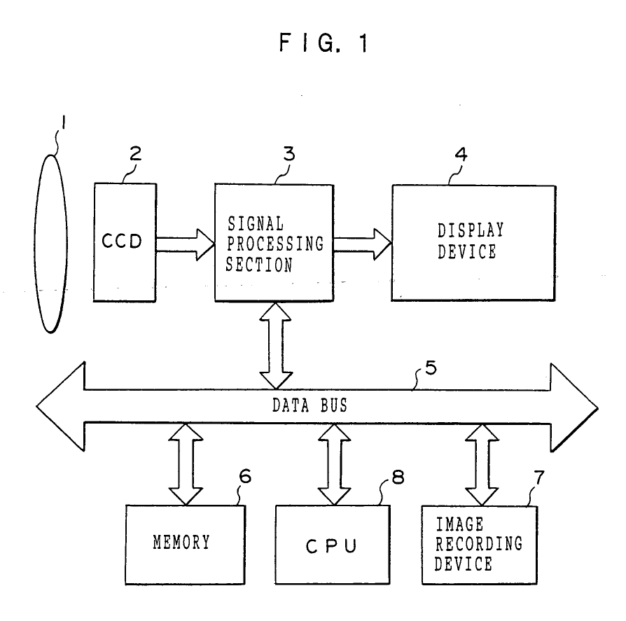

FIG. 1 is a block diagram showing the structure of an image pickup device relating to an embodiment of the present invention.

The image pickup device has a CCD image sensor 2 generating an image signal in accordance with light incident via an image pickup lens 1; a signal processing section 3 which, after the image signal generated at the CCD image sensor 2 is converted into a digital signal, executes a predetermined signal processing thereon; and a display device 4 displaying an image based on the image signal which has been subjected to the signal processing.

The image pickup device also has a memory 6 storing the image signal supplied via a data bus 5 from the signal processing section 3; an image recording device 7 recording the image signal on a recording medium; and a central processing unit (CPU) 8 controlling the entire device.

The display device 4 is formed from, for example, an LCD, and displays images based on image signals directly supplied from the signal processing section 3, and on image signals recorded by the image recording device 7. The image recording device 7, for example, may record image signals in a non-volatile semiconductor memory such as a flash memory or the like, or may record image signals on a magnetic disk or an optical disk.

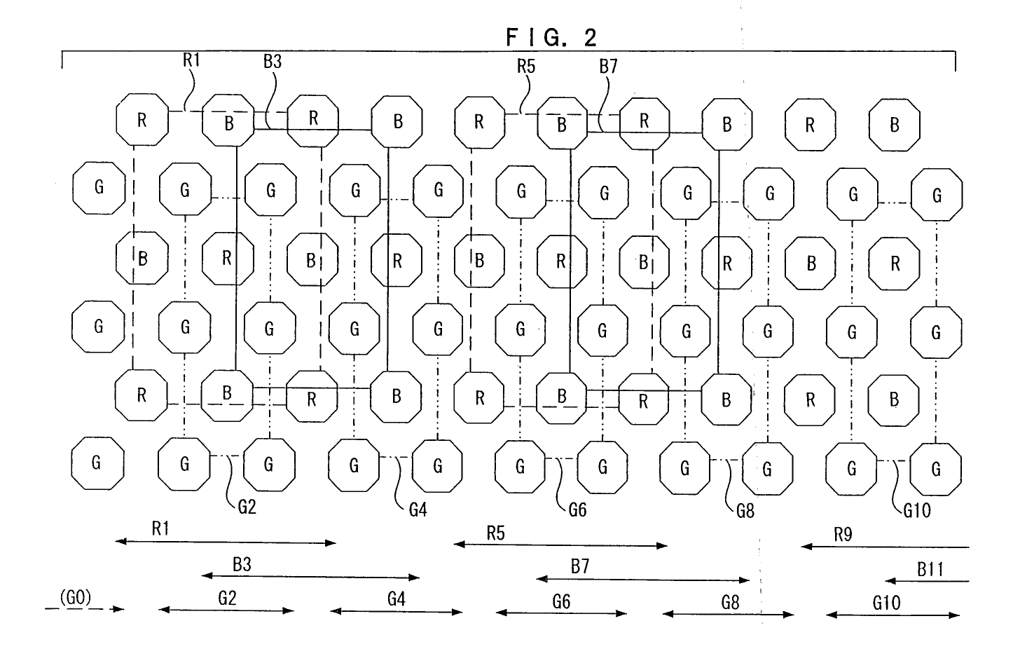

FIG. 2 is a diagram showing the arrangement of photodiodes of the CCD image sensor 2. At the CCD image sensor 2, pixels are disposed in a honeycomb arrangement.

At the CCD image sensor 2, pixels (photodiodes) having hexagonal configurations are disposed alternately (such that a square grid is rotated by substantially 45°). For example, at the odd-numbered rows, pixels of R (red), B (blue), R, B, R, B, . . . are disposed alternately. At the even-numbered rows, only G (green) pixels are disposed at positions between the pixels of the odd-numbered rows. Further, at the odd-numbered rows, the B, R, B, R, . . . pixels are disposed alternately at positions between the G pixels, and at the even-umbered rows, only the G pixels are disposed at the positions between the pixels of the odd-numbered rows. Signals from the respective pixels are read-out, and the read-out signals are supplied to the signal processing section 3.

At the image pickup device which is structured as described above, in consideration of the fact that there is correlation among R, G, B, the signal processing section 3 interpolates respective pixels of RGB by carrying out the following signal processing on the signals which have been read-out from the respective pixels.

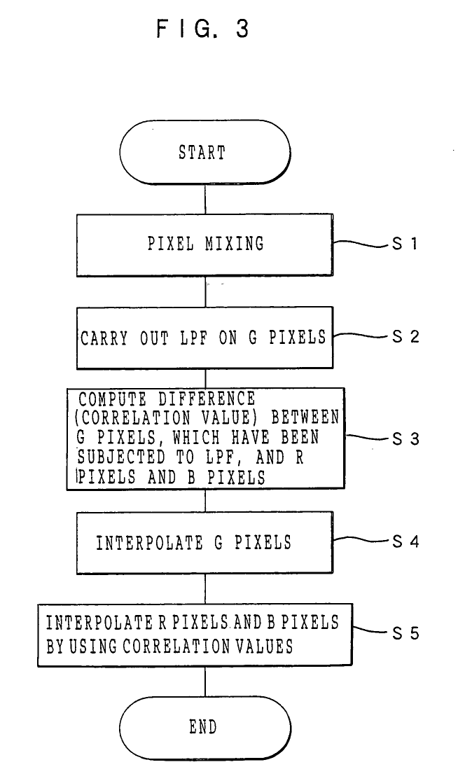

FIG. 3 is a flowchart showing the order of processings of pixel interpolation by the signal processing section 3. Namely, the signal processing section 3 interpolates respective pixels of RGB by carrying out the processings from step S1 to step S5.

In step S1, the signal processing section 3 carries out pixel mixing for each of RGB by utilizing the image signals which were generated at the CCD image sensor 2 and have been converted into digital signals.

For example, as shown in FIG. 2, with respect to R and B, as a result of mixing together pixels which form a smallest quadrangle among four pixels of the same color, one new pixel (R1, B3, R5, B7) is formed. With respect to G, as a result of mixing together, among six pixels of the same color, pixels forming a rectangle whose longitudinal direction is the column direction, one new pixel (G2, G4, G6, . . . ) is formed. Note that the lower portion of FIG. 2 shows the mixing intervals (hereinafter, simply called “intervals”) of R1, R5, R9, B3, B7, B11, G2, G4, G6, G8, G10, which have each become one pixel.

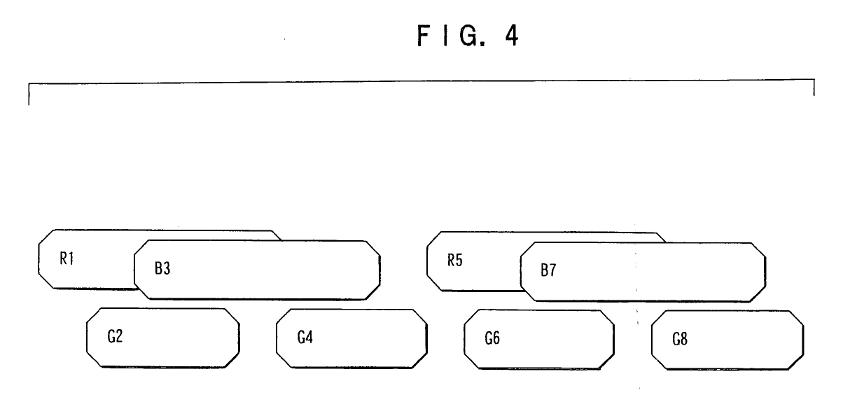

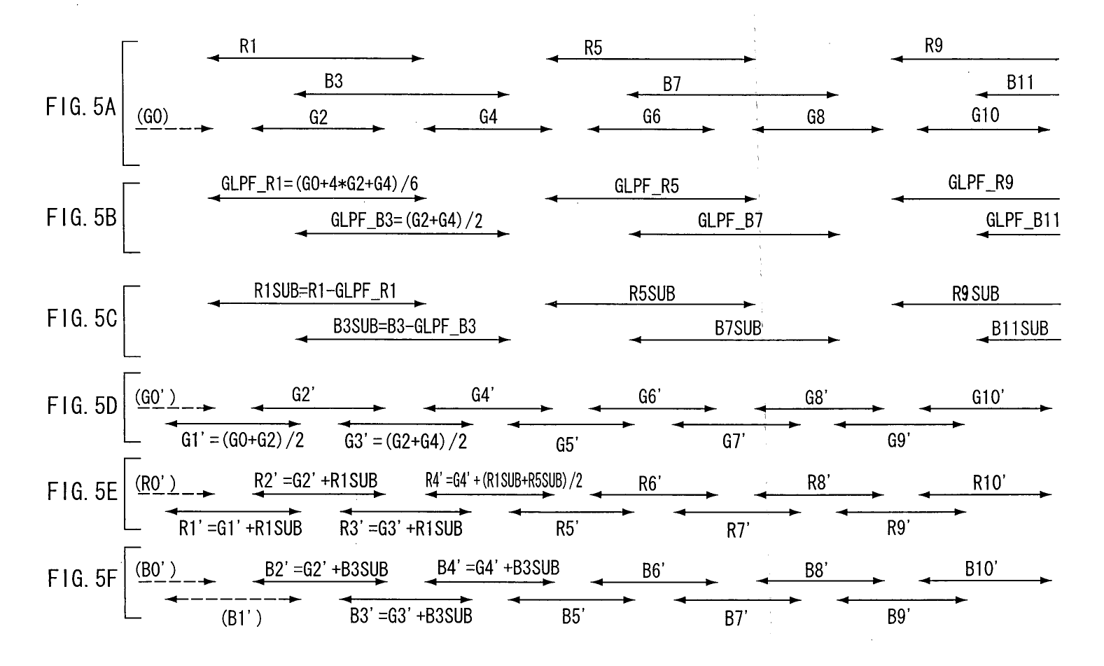

FIGS. 4 and 5A are diagrams showing spatial phase offset for pixels obtained by the pixel mixing of step S1. As shown in these figures, R1, B3, R5, B7 are not uniform intervals, and the phases of the R pixels are close to the phases of the B pixels. Further, the intervals of the R pixels (the same holds for the B pixels) are different than the intervals of the G pixels, and the spatial frequency component of the G pixels is higher than that of the R pixels.

In this way, after the processing of step S1, there is phase offset at the R pixels, and there is a difference in the spatial frequency components of the R pixels (the same holds for the B pixels) and the G pixels. Therefore, the correlation relationships among RGB (in the present embodiment, the correlation relationship between R and G, and the correlation relationship between B and G) cannot be determined in this state. Thus, the signal processing section 3 moves onto following step S2.

In step S2, the signal processing section 3 carries out low-pass filter (LPF) processing on the G pixels. In this way, the correlation between the R pixels and the G pixels, and the correlation between the B pixels and the G pixels can be obtained, and the routine moves onto step S3. For example, a G pixel (GLPF_R1) corresponding to R1 and a G pixel (GLPF_B3) corresponding to B3 are determined as follows.
GLPF_{—}R1=(G0+G2*4+G4)/6
GLPF_{—}B3=(G2+G4)/2

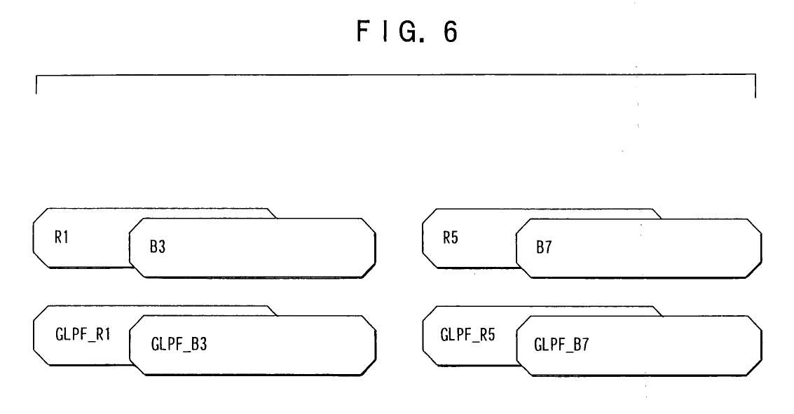

FIG. 6 is a diagram showing GLPF_R1 and GLPF_B3 which are G pixels after the LPF processing. FIG. 5B is a diagram showing GLPF_R1, GLPF_B3, GLPF_R5, GLPF_B7, GLPF_R9, and GLPF_B11, which are G pixels after the LPF processing. As shown in these drawings, the interval of R1 and the interval of GLPF_R1, and the interval of B3 and the interval of GLPF_B3, coincide. Further, not only the intervals, but also the phases match.

In order to correspond to the intervals and the phases of the R pixels and the B pixels after the pixel mixing, it suffices for the signal processing section 3 to carry out the LPF processing on the G pixels, and the processing is not limited to the aforementioned mathematical formulas.

In step S3, the signal processing section 3 computes the differences (phase difference values) between the G pixels which have been subjected to the LPF and the R pixels and the B pixels, and moves onto step S4. FIG. 5C is a diagram showing the correlation values of the G pixels which have been subjected to the LPF, and the R pixels and the B pixels. The signal processing section 3 carries out the following computation on, for example, correlation values R1SUB, B3SUB.
R1SUB=R1−GLPF_{—}R1
B3SUB=B3−GLPF_{—}B3

R1SUB expresses the correlation value of R1 (red) and GLPF_R1 (green). B3SUB expresses the correlation value of B3 (blue) and GLPF_B3 (green). As shown in FIG. 5C, similarly, the signal processing section 3 carries out computation for correlation values R5SUB, B7SUB, R9SUB, B11SUB, . . . as well. Here, subtraction is performed to determine the correlation values, but another operation may be carried out.

In step S4, the signal processing section 3 interpolates between the G pixels as per the following formulas, and moves on to step S5. FIG. 5D is a diagram showing the G pixels after interpolation processing.
G1′=(G0+G2)/2
G2′=G2
G3′=(G2+G4)/2
G4′=G4

Generalizing the above formulas results in the following.
Gn′=(G(n−1)+G(n+1))/2 (when n is an odd number)
Gn′=Gn (when n is an even number)

In step S5, the signal processing section 3 interpolates the R pixels and the B pixels, by using the correlation values determined in step S3. FIG. 5E is a diagram showing the R pixels after interpolation, and FIG. 5F is a diagram showing the B pixels after interpolation. Concretely, by adding the correlation values to the G pixels as per the following formulas, the R pixels and the B pixels are interpolated.
R2′=G2′+R1SUB
R3′=G3′+R1SUB
R4′=G4′+(R1SUB+R5SUB)/2
B2′=G2′+B3SUB
B3′=G3′+B3SUB
B4′=G4′+B3SUB

As a result, Rn′ (where n is a natural number) is generated (interpolated) by Gn′ which is determined by the interpolation processing of step S4, and the correlation value of G and R at which there is no phase offset in step S3. Therefore, as shown in FIG. 5D and FIG. 5E, Rn′ can reproduce a spatial frequency and a phase which are similar to those of Gn′. Further, because Rn′ is generated by using the correlation with Gn′, false colors can be suppressed. Similarly and as shown in FIG. 5D and FIG. 5F, Bn′ as well can reproduce a spatial frequency and a phase which are similar to those of Gn′. Further, because Bn′ also is generated by using the correlation with Gn′, false colors can be suppressed.

The reason why [(R1SUB+R5SUB)/2] is used in calculating R4′ is because G4′, which is used when computing R4′, has correlation with both R1SUB and R5SUB.

As described above, by carrying out LPF processing on G pixels so as to correspond to the intervals and the phases of R pixels and B pixels, the image pickup device relating to the embodiment of the present invention can determine correlation values between G pixels after LPF processing and R pixels or B pixels.

Moreover, due to the above-described image pickup device interpolating R pixels and B pixels on the basis of the G pixels and the correlation values, R pixels and B pixels, which are a similar spatial frequency as the G pixels after the interpolation processing and which have no phase offset, can be obtained. Because these R pixels and B pixels are determined by taking the correlation with the G pixels into consideration, false colors can be suppressed.

The present invention is not limited to the above-described embodiment, and can also be applied to structures whose designs are changed within the scope of the matter recited in the claims. For example, the mathematical formulas expressing the LPF processing, the mathematical formulas expressing the correlation values, and the like are not particularly limited. Further, the above-described image pickup device may pick-up moving images or may pick-up still images.

What is claimed is:

1. An image pickup device comprising:
a solid state image pickup element in which pixels of red color and blue color are disposed alternately in even-numbered rows and only pixels of green color are disposed in odd-numbered rows, or in which pixels of red color and blue color are disposed alternately in odd-numbered rows and only pixels of green color are disposed in even-numbered rows, the plurality of pixels being disposed in a state in which a square grid is rotated by substantially 45°;
a pixel mixing component mixing together each predetermined number of signals of same-colored pixels read-out from the solid state image pickup element, and generating a pixel signal for each of red color, green color and blue color;
a filter carrying out filter processing on the pixel signal of green color generated by the pixel mixing component, so as to correspond to a mixing interval of the pixel signal of red color or blue color generated by the pixel mixing component;
a correlation value computing component computing a correlation value of the pixel signal of red color or blue color generated by the pixel mixing component, and the pixel signal of green color which has been subjected to the filter processing; and
an interpolating component generating interpolation signals of red color or blue color, on the basis of the pixel signal of green color generated by the pixel mixing component, and the correlation value computed by the correlation value computing component.

2. The image pickup device of claim 1, wherein the interpolating component
generates interpolation signals of green color on the basis of the pixel signal of green color generated by the pixel mixing component, and
on the basis of the interpolation signals of green color and the correlation value, generates interpolation signals of red color or blue color of a same spatial frequency as a spatial frequency of the interpolations signal of green color.

3. The image pickup device of claim 1, wherein the filter carries out the filter processing on the pixel signal of green color, so as to correspond to a phase of the pixel signal of red color or blue color.

4. The image pickup device of claim 1, wherein the filter is a low-pass filter.

5. The image pickup device of claim 1, wherein the correlation value is a difference between the pixel signal of red color or blue color generated by the pixel mixing component, and the pixel signal of green color which has been subjected to the filter processing.

6. A signal processing method comprising:
mixing together each predetermined number of signals of same-colored pixels from a solid state image pickup element in which pixels of red color and blue color are disposed alternately in even-numbered rows and only pixels of green color are disposed in odd-numbered rows, or in which pixels of red color and blue color are disposed alternately in odd-numbered rows and only pixels of green color are disposed in even-numbered rows, and in which the plurality of pixels are disposed in a state in which a square grid is rotated by substantially 45°, and generating a pixel signal for each of red color, green color and blue color;
carrying out filter processing on the pixel signal of green color, so as to correspond to a mixing interval of the generated pixel signal of red color or blue color;
computing a correlation value of the generated pixel signal of red color or blue color, and the pixel signal of green color which has been subjected to the filter processing; and
generating interpolation signals of red color or blue color, on the basis of the generated pixel signal of green color and the computed correlation value.

7. The signal processing method of claim 6, wherein
interpolation signals of green color are generated on the basis of the generated pixel signal of green color, and
interpolation signals of red color or blue color of a same spatial frequency as a spatial frequency of the interpolation signals of green color are generated on the basis of the interpolation signals of green color and the correlation value.

8. The signal processing method of claim 6, wherein the filter processing is carried out on the pixel signal of green color, so as to correspond to a phase of the pixel signal of red color or blue color.

9. The signal processing method of claim 6, wherein the filter processing allows the pixel signal to pass through a low frequency.

10. The signal processing method of claim 6, wherein the correlation value is a difference between the generated pixel signal of red color or blue color, and the pixel signal of green color which has been subjected to the filter processing.
